(19) United States
(12) Patent Application Publication
(10) Pub. No.: US 2005/0076347 A1
(43) Pub. Date: Apr. 7, 2005

(54) Disc drive for disc flutter improvement in high driving speed and method

(75) Inventors: Hsien Tsung Chiu, Kweishan (TW); Huang Chiao Fan, Kweishan (TW)

Correspondence Address: Richard P. Berg, Esq.;c/o LADAS & PARRY, Suite 2100, 5670 Wilshire Boulevard, Los Angeles, CA, 90036-5679, US

(73) Assignee: BENQ CORPORATION

(21) Appl. No.: 10/956,394

(22) Filed: Oct. 1, 2004

(30) Foreign Application Priority Data
Oct. 3, 2003 (TW) 092127514

(51) Int. Cl. G11B 17/03; G11B 17/04; G11B 33/02

(52) U.S. Cl. 720/601

(57) ABSTRACT

The present invention provides an optical information recording/reproducing apparatus, which comprises a tray and a chassis. The chassis comprises two side walls, and at least one raising rib is set on at least one of the two side walls. While the optical information recording/reproducing apparatus accommodates the optical information recording medium in a vertical manner, the raising rib comes into contact with the edge of the optical information recording medium for raising the optical information recording medium. The shape of the raising rib is designed to match the arc-shaped edge of the accommodation recess surface to reduce the disturbance of the air current while the optical information recording/reproducing apparatus rotates the optical information recording medium.

### BACKGROUND OF THE INVENTION

1. Field of the Invention

The present invention relates to an optical information recording/reproducing apparatus, especially to the design of an optical information recording/reproducing apparatus, so that the optical information recording medium will not vibrate while rotating in high speed.

2. Description of the Prior Art

The CD-ROM drive of the prior art comprises a tray. There is an accommodation recess surface, which is bigger than a compact disc, on the tray for accommodating the compact disc and sending the compact disc into the CD-ROM drive horizontally. The compact disc is fixed at a predetermined reading/writing position by a disc holder. While the compact disc rotates in the CD-ROM drive, the optical reading/writing head reads/writes data from/into the different areas on the compact disc.

In the vertical computer system of the prior art, the CD-ROM drive is assembled vertically instead of horizontally. If the CD-ROM drive is assembled vertically, because the accommodation recess surface is bigger than the compact disc, the compact disc will not be maintained at the center of the accommodation recess surface and will be at the bottom of the accommodation recess surface. The offset of the compact disc results in that the disc holder cannot fix the compact disc at the predetermined position, and the optical reading/writing head also cannot read/write data from/into the correct position. Therefore, a raising rib is added to the vertical CD-ROM drive of the prior art for raising the compact disc to the correct position.

Please refer to FIG. 1. FIG. 1 is a schematic diagram of the raising rib 8 of the vertical CD-ROM drive of the prior art. When the compact disc 6 enters the CD-ROM drive with the tray, the raising rib 8 on the side walls under the tray comes in contact with the edge of the compact disc 6, so that the compact disc 6 is raised to the height of the disc holder, and the CD-ROM can read/write data successfully.

While the compact disc 6 rotates, an air current will be generated in the chink between the compact disc 6 and the edge of the accommodation recess surface. However, the design of the raising rib of the prior art makes the shape of the chink irregularly, so that the air current cannot pass through smoothly. While the compact disc 6 rotates in high speed, the air current will make the compact disc 6 vibrate, so that the reading/writing quality is influenced.

### SUMMARY OF THE INVENTION

The objective of the present invention is to provide an optical information recording/reproducing apparatus to improve the problem of vibration as the compact disc rotates in high speed.

The optical information recording/reproducing apparatus of the present invention comprises a tray and a chassis. The tray has an accommodation recess surface with an arc-shaped edge for placing an optical information recording medium. The chassis comprises two side walls, a chassis entrance, and a raising rib set on the side walls. The tray is set between the two side walls by a sliding manner for moving inside or outside the chassis entrance selectively. While the optical information recording/reproducing apparatus accommodates the optical information recording medium in a vertical manner, the raising rib comes in contact with the edge of the optical information recording medium for raising the optical information recording medium. Moreover, while the optical information recording/reproducing apparatus rotates the optical information recording medium, an air current is generated around the arc-shaped edge of the accommodation recess surface. The shape of the raising rib is designed to match the arc-shaped edge of the accommodation recess surface to reduce the disturbance of the air current while the optical information recording/reproducing apparatus rotates the optical information recording medium.

The optical information recording/reproducing apparatus of the present invention modifies the shape of the raising rib to reduce the disturbance of the air current generated by the raising rib while the optical information recording/reproducing apparatus rotates the optical information recording medium.

The advantage and spirit of the invention may be understood by the following recitations together with the appended drawings.

### BRIEF DESCRIPTION OF THE APPENDED DRAWINGS

FIG. 1 is a schematic diagram of the raising rib of the vertical CD-ROM drive of the prior art.

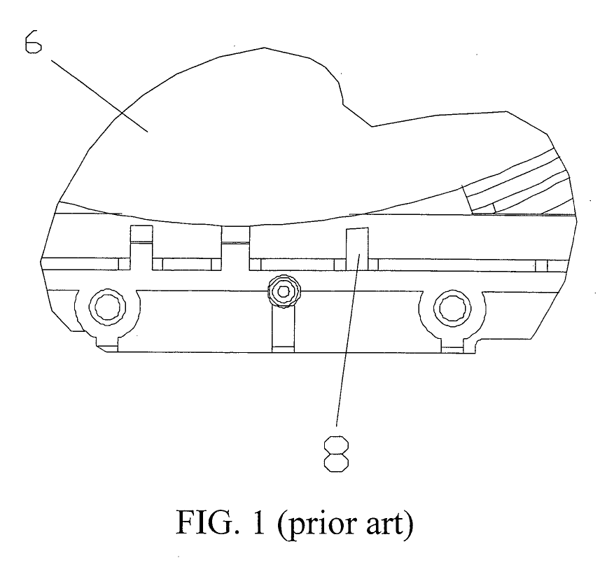

FIG. 2 is an apparent diagram of the optical information recording/reproducing apparatus of the present invention.

FIG. 3 is an apparent diagram of the chassis shown in FIG. 2.

FIG. 4 is a schematic diagram of the optical information recording/reproducing apparatus and the optical information recording medium shown in FIG. 2.

FIG. 5 is an enlarged diagram of the raising rib shown in FIG. 3.

FIG. 6 is another embodiment of the optical information recording/reproducing apparatus of the present invention.

FIG. 7 is another embodiment of the optical information recording/reproducing apparatus of the present invention.

### DETAILED DESCRIPTION OF THE INVENTION

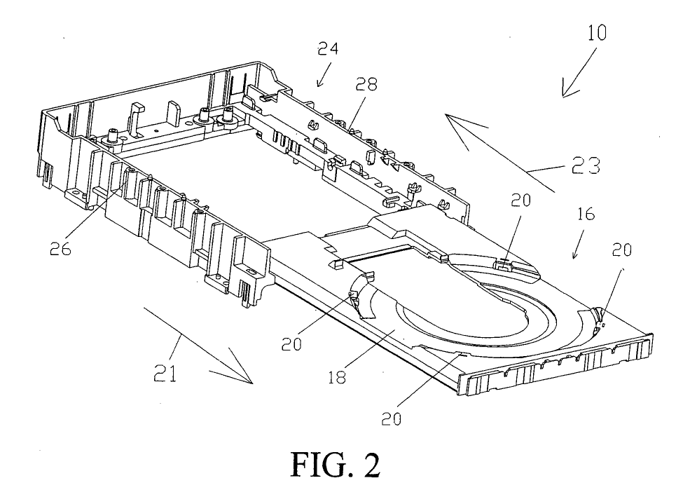

Please refer to FIG. 2. FIG. 2 is an apparent diagram of the optical information recording/reproducing apparatus 10 of the present invention. The optical information recording/reproducing apparatus 10 comprises a tray 16 and a chassis 24. The tray 16 has an accommodation recess surface 18 with an arc-shaped edge for placing an optical information recording medium and 4 clamps 20 which are set on the circumference of the accommodation recess surface 18 and stick out of the recess surface. The clamps 20 are used for preventing the optical information recording medium from falling out of the accommodation recess surface 18. The chassis 24 comprises two side walls, top side wall 28 and bottom side wall 26, and a chassis entrance. The tray 16 is set between the top side wall 28 and the bottom side wall 26 in a sliding manner for moving inside or outside the chassis entrance selectively. The arrows 21 and 23 shown in FIG. 2 represent the direction of the tray 16 moving inside or outside respectively.

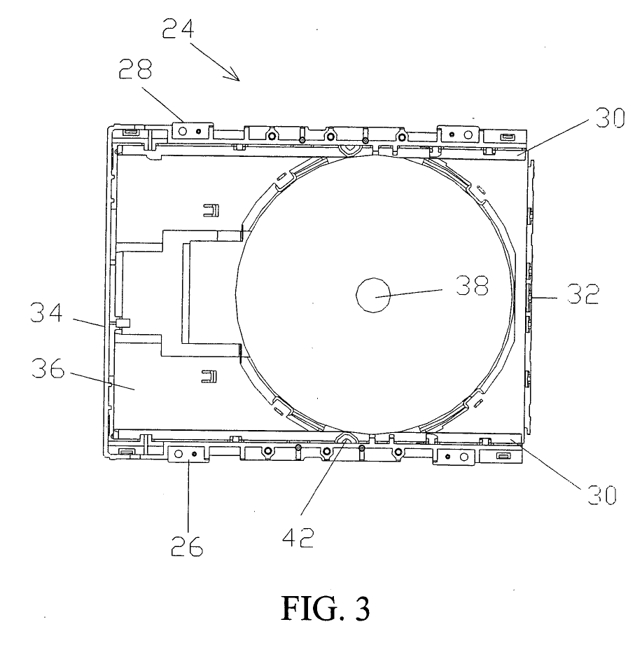

Please refer to FIG. 3. FIG. 3 is an apparent diagram of the chassis 24 shown in FIG. 2. The chassis 24 has a square external frame, which comprises a top side wall 28, a bottom side wall 26, a front wall 32, a back wall, and a base 36. A guiding groove 30 is set on each side wall 28 and 26 of the chassis 24 respectively for guiding the tray to move inside or outside the chassis entrance. The optical information recording/reproducing apparatus 10 comprises a disc holder 38 set on the base 36. The chassis 24 is set on a computer system (not shown in FIG.) vertically. A raising rib 42 is set on the bottom side wall 26.

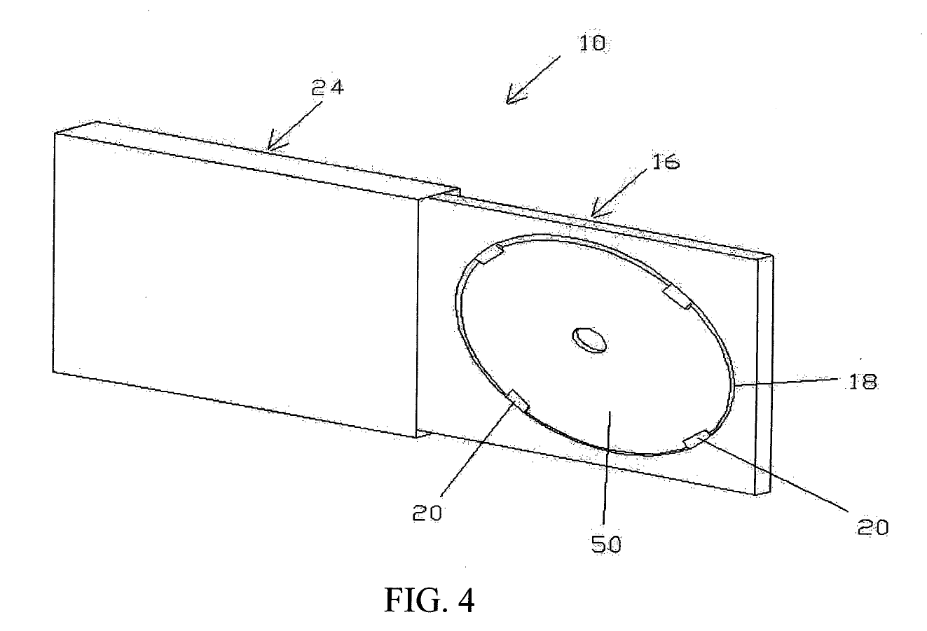

Please refer to FIG. 4. FIG. 4 is a schematic diagram of the optical information recording/reproducing apparatus 10 and the optical information recording medium 50 shown in FIG. 2. The optical information recording medium 50 is a circular compact disc. The clamps 20 stick out of the accommodation recess surface 18. While the optical information recording medium is placed on the accommodation recess surface 18, the ends of the clamps 20 will support the optical information recording medium 50 to stand on the accommodation recess surface 18.

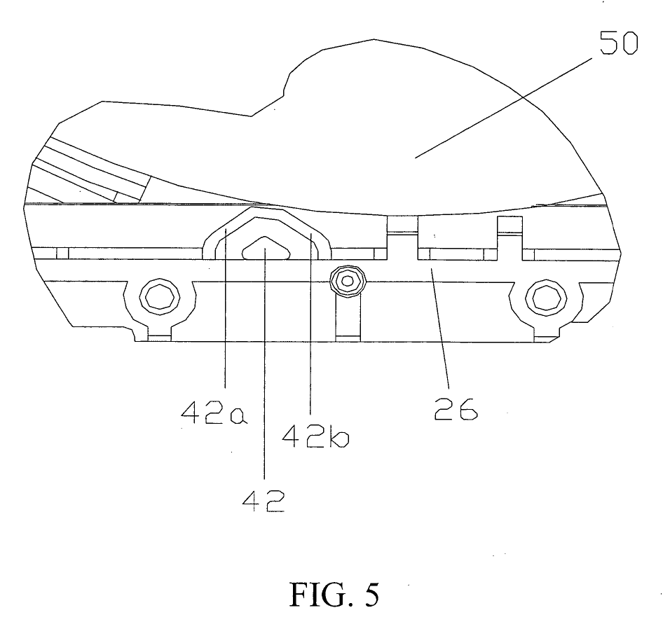

Please refer to FIG. 5. FIG. 5 is an enlarged diagram of the raising rib 42 shown in FIG. 3. The raising rib 42 is an arc-shaped protrusion structure expended from the side wall 26 of the chassis 24 to the circumference of the accommodation recess surface 18. While the optical information recording/reproducing apparatus 10 (not shown in FIG. 5) accommodates the optical information recording medium 50 in a vertical manner, and the optical information recording medium 50 enters the optical information recording/reproducing apparatus 10 (not shown in FIG. 5) with the tray 16 (not shown in FIG. 5), the raising rib 42 set on the bottom side wall comes into contact with the edge of the optical information recording medium 50 for raising the optical information recording medium to the height of the disc holder (not shown in FIG. 5) and fixing with the disc holder. Therefore, the optical information recording medium 50 rotates with a predetermined center.

While the optical information recording medium 50 is placed on the accommodation recess surface 18 with an arc-shaped edge, there is a chink between the optical information recording medium 50 and the accommodation recess surface 18. While the optical information recording medium rotates in high speed of over 10,000 rpm, an air current is generated around the chink between the optical information recording medium 50 and the arc-shaped edge of the accommodation recess surface 18, and the air current flows along the arc-shaped edge of the accommodation recess surface 18. The shape of the raising rib is designed to match the arc-shaped edge of the accommodation recess surface like the diversion board of a vehicle. While the air current passes through the raising rib 42, the rising incline 42a of the raising rib 42 directs the air current to rise smoothly and pass through the raising rib 42, and the dropping incline 42b of the raising rib 42 is helpful for the air current to flow out rapidly.

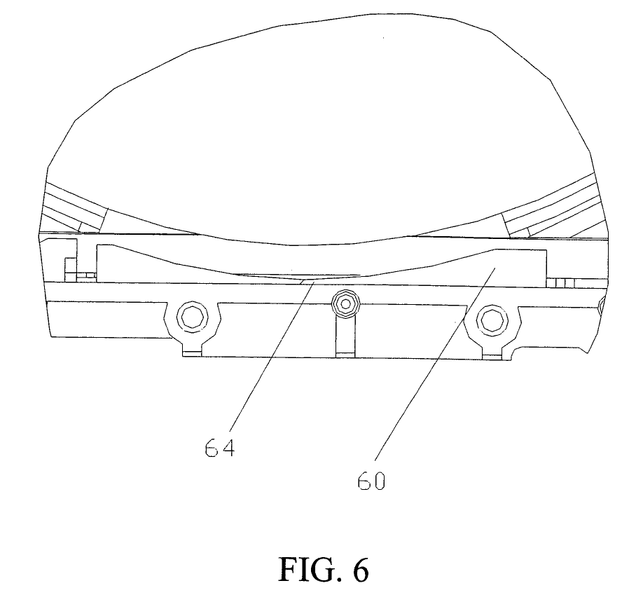

Please refer to FIG. 6. FIG. 6 is another embodiment of the optical information recording/reproducing apparatus of the present invention. In this embodiment, the raising rib 60 has an arc-shaped surface 64 formed by the bottom side wall 26 along the edge of the accommodation recess surface 18. The raising rib 42 shown in FIG. 5 is replaced by the raising rib 60 to raise the optical information recording medium 50 (not shown). The arc-shaped surface of the raising rib 60 in this embodiment can also direct the air current to pass through as smoothly as the raising rib 42. The characteristic and efficiency will not be described in detail again.

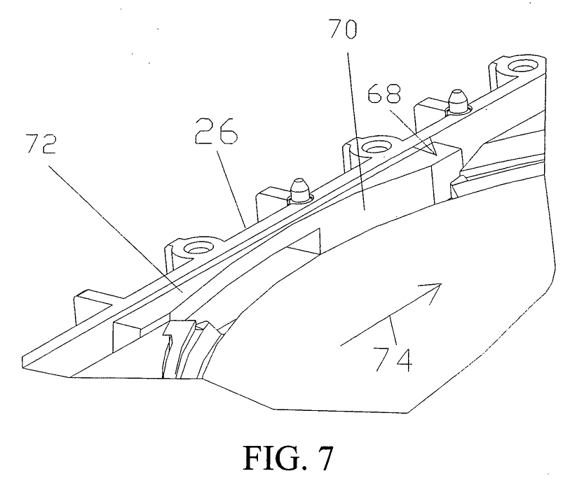

Please refer to FIG. 7. FIG. 7 is another embodiment of the optical information recording/reproducing apparatus of the present invention. The raising rib 42 on the bottom side wall 26 shown in FIG. 3 is replaced by the raising rib 68. The arc-shaped surface of the raising rib 68 comprises a back arc-shaped surface 70 and a front arc-shaped surface 72. The back arc-shaped surface 70 has a smooth arc-shaped surface, and the front arc-shaped surface 72 has a recess located on its latter portion, near the circumference of the accommodation recess surface 18. The recess of the front arc-shaped surface 72 is designed for essentially preventing the arc-shaped air current channel from being blocked. The arrow 74 represents the direction of the tray 16 (not shown) moving inward. The design of the raising rib 68 enables that while the optical information recording medium 50 (not shown) is placed on the tray 16 (not shown) and is moved into the entrance of the housing, it reaches a predetermined reading/writing position via the recess of the front arc-shaped surface 72; this also prevents the front arc-shaped surface 72 from blocking the optical information recording medium 50 (not shown) to move inside.

TABLE 1

| | | Preferred | Preferred | Preferred |
|---|---|---|---|---|
| | | embodiment | embodiment | embodiment |
| | Prior art | (1) | (2) | (3) |
| Test 1 | 90 | 30 | 29 | 27 |
| Test 2 | 72 | 30 | 29 | 23 |
| Test 3 | 110 | 32 | 30 | 22 |
| Test result | Not pass | Pass | Pass | Pass |

### Unit: Number of Unreadable File

Please refer to table 1. Table 1 is the test results of comparing the present invention with the work stability of the compact disc of the prior art. The test utilizes a software, CD-Scan of CD-Speed, to compile statistics according to the unreadable files on the optical information recording medium recorded by the prior art and three embodiments of the present invention. If the optical information recording medium is more unstable while it is running, there will be more unreadable files correspondingly. The test is repeated three times, as in test 1, test 2, and test 3 respectively, in the environment of 20±1° C., and the optical information recording medium is rotated with the speed of 10560 RPM.

The preferred embodiment 1 represents the optical information recording/reproducing apparatus that applies the raising rib 42. The preferred embodiment 2 represents the optical information recording/reproducing apparatus that applies the raising rib 60. The preferred embodiment 3 represents the optical information recording/reproducing apparatus that applies the raising rib 68. Besides the raising rib, the above three apparatus are all the same. According to table 1, the number of unreadable files of the experimentation of the present invention has been significantly reduced. The present invention can effectively reduce the flutter while the optical information recording medium is rotated.

Compared with the prior art, the optical information recording/reproducing apparatus of the present invention modifies the shape of the raising rib to reduce the disturbance of the air current generated by the raising rib while the optical information recording/reproducing apparatus rotates the optical information recording medium, thus improving the quality of reading/writing.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. An optical information recording/reproducing apparatus comprising:
a tray having an accommodation recess surface with an arc-shaped edge for placing an optical information recording medium; and
a chassis comprising two side walls and a chassis entrance, at least one raising rib being set on at least one of the two side walls, the tray being set between the two side walls by a sliding manner for moving inside or outside the chassis entrance selectively, while the optical information recording/reproducing apparatus accommodates the optical information recording medium in a vertical manner, and the optical information recording medium enters the optical information recording/reproducing apparatus with the tray, the raising rib contacts the edge of the optical information recording medium for raising the optical information recording medium;
wherein the shape of the raising rib is designed to match the arc-shaped edge of the accommodation recess surface.

2. The optical information recording/reproducing apparatus of claim 1, wherein the two side walls of the chassis are respectively located on a top side and a bottom side of the optical information recording/reproducing apparatus.

3. The optical information recording/reproducing apparatus of claim 2, wherein a guiding groove is set on each side wall of the chassis respectively for guiding the tray to move inside or outside the chassis entrance.

4. The optical information recording/reproducing apparatus of claim 1, wherein the optical information recording/reproducing apparatus comprises a disc holder, while the raising rib raises the optical information recording medium, the disc holder fixes the optical information recording medium at a predetermined reading/writing position.

5. The optical information recording/reproducing apparatus of claim 1, wherein the tray comprises at least one clamp set on the circumference of the accommodation recess surface for preventing the optical information recording medium from falling out of the accommodation recess surface.

6. The optical information recording/reproducing apparatus of claim 1, wherein the raising rib is an arc-shaped protrusion structure expended from the side wall of the chassis to the circumference of the accommodation recess surface.

7. The optical information recording/reproducing apparatus of claim 1, wherein the raising rib is an arc-shaped surface expended from the side wall of the chassis to the circumference of the accommodation recess surface.

8. The optical information recording/reproducing apparatus of claim 7, wherein the arc-shaped surface of the raising rib comprises a front arc-shaped surface and a back arc-shaped surface, the back arc-shaped surface has a smooth arc-shaped surface, the front arc-shaped surface has a recess located on the latter portion of the front arc-shaped surface near the circumference of the accommodation recess surface.

9. The optical information recording/reproducing apparatus of claim 8, wherein while the optical information recording medium is placed on the accommodation recess surface of the tray and moved into the entrance of the housing, the optical information recording medium reaches a predetermined reading/writing position via the recess for preventing the front arc-shaped surface from blocking the optical information recording medium to move inside.

10. The optical information recording/reproducing apparatus of claim 1, wherein the optical information recording medium is a circular compact disc.

11. The optical information recording/reproducing apparatus of claim 1, wherein the optical information recording medium rotates in high speed of over 10,000 rpm.
